(19) United States
(12) Patent Application Publication
(10) Pub. No.: US 2026/0371426 A1
(43) Pub. Date: Nov. 19, 2026

(54) WIRELESS COMMUNICATION APPARATUS, AND CONTROL METHOD FOR WIRELESS COMMUNICATION APPARATUS

(71) Applicant: CANON KABUSHIKI KAISHA, Tokyo (JP)

(72) Inventor: Daisuke Kawakami, Tokyo (JP)

(21) Appl. No.: 19/671,689

(22) Filed: May 8, 2026

(30) Foreign Application Priority Data
May 16, 2025 (JP) 2025-082854

(51) Int. Cl. H04W 76/15; H04W 84/12

(52) U.S. Cl. CPC H04W 76/15; H04W 84/12

(57) ABSTRACT

A wireless communication apparatus, conforming to an IEEE 802.11 series standard, performs receiving a first Service Discovery Frame (SDF) from a partner apparatus without intervention of an access point, the first SDF including first information that makes it possible to identify whether the partner apparatus is capable of establishing a plurality of links with another communication apparatus and establishing Multi-Link connection with the partner apparatus without intervention of the access point in a case where the received first information indicates that the partner apparatus is capable of establishing a plurality of links with another communication apparatus.

### BACKGROUND

### FIELD OF THE TECHNOLOGY

The present disclosure relates to a wireless communication apparatus capable of establishing a plurality of links simultaneously, and a control method for the wireless communication apparatus.

### DESCRIPTION OF THE RELATED ART

With a recent increase in the amount of data used in communication, the development of such communication techniques as a wireless local area network (LAN) is underway. The standards of the series of the Institute of Electrical and Electronics Engineers (IEEE) 802.11 are known as major communication standards of the wireless LAN. The standards of the IEEE 802.11 series include such standards as the IEEE 802.11a/b/g/n/ac/ax. The IEEE 802.11ax, which is the latest standard, standardizes a technique to improve a communication speed in a crowded environment, in addition to a high peak throughput of up to 9.6 gigabits per second (Gbps), with use of OFDMA (the orthogonal frequency multiple access) (Japanese Patent Laid-Open No. 2023-51567). Here, OFDMA is an abbreviation of Orthogonal Frequency-Division Multiple Access.

A task group called the IEEE 802.11be has been launched as a successor standard aiming for a further improvement in the throughput, improvement in the efficiency of use of frequencies, and improvement in communication latency. The IEEE 802.11be standard discusses Multi-Link communication in which, for example, one access point (AP) establishes a plurality of links with one station (STA) via a plurality of different frequency channels and performs communications in parallel.

Meanwhile, Wi-Fi Alliance, which develops authentication programs for wireless LAN devices, has developed a WFD standard that prescribes a procedure for establishing a communication link between wireless LAN stations by exchanging communication parameters between the stations without intervention of an access point. WFD is an acronym for Wi-Fi Direct. With WFD, there is also discussion of a method of scanning for a partner apparatus with use of a Service Discovery Frame (SDF), which has been adopted in Wi-Fi Aware as well, to reduce the time period from the discovery of a partner apparatus to connection.

In a case where a partner apparatus is scanned for with use of a Service Discovery Frame, a notification of information indicating whether the partner apparatus can establish Multi-Link connection is not provided. This gives rise to a problem of low convenience when a communication apparatus scans for a partner apparatus when making a connection by establishing a plurality of links.

### SUMMARY

The present disclosure has been made in view of the aforementioned problem. To solve the aforementioned problem, a wireless communication apparatus according to an aspect of the present disclosure is a wireless communication apparatus conforming to an IEEE 802.11 series standard, the wireless communication apparatus comprising: at least one memory that stores a set of instructions; and at least one processor that executes the instructions, the instructions, when executed, causing the wireless communication apparatus to perform operations comprising: receiving a first Service Discovery Frame (SDF) from a partner apparatus without intervention of an access point, the first SDF including first information that makes it possible to identify whether the partner apparatus is capable of establishing a plurality of links with another communication apparatus; and establishing Multi-Link connection with the partner apparatus without intervention of the access point in a case where the received first information indicates that the partner apparatus is capable of establishing a plurality of links with another communication apparatus.

Convenience can be improved when a communication apparatus scans for a partner apparatus when making a connection by establishing a plurality of links.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram showing an exemplary configuration of a network according to the present embodiment.

FIG. 2 is a diagram showing an exemplary hardware configuration of wireless communication apparatuses.

FIG. 3 is a diagram showing an exemplary functional configuration of the wireless communication apparatuses.

FIG. 4 is a diagram showing an exemplary sequence of Wi-Fi Direct processing for detecting a partner apparatus.

FIG. 5 is a diagram showing an example of connection processing after detecting a partner apparatus.

FIG. 6 is a diagram showing another example of connection processing after detecting a partner apparatus.

FIG. 7 is a diagram showing an example of processing executed by wireless communication apparatuses according to the present embodiment.

FIG. 8 is a diagram showing a structure of an SDF according to the present embodiment.

FIG. 9 is a diagram showing an example of an AFWA field according to the present embodiment.

FIG. 10 is a diagram showing another example of an AFWA field according to the present embodiment.

FIG. 11 is a diagram showing an example of a P2P Capability field according to the present embodiment.

FIG. 12 is a diagram showing another example of a P2P Capability field according to the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Configuration of Wireless Communication System

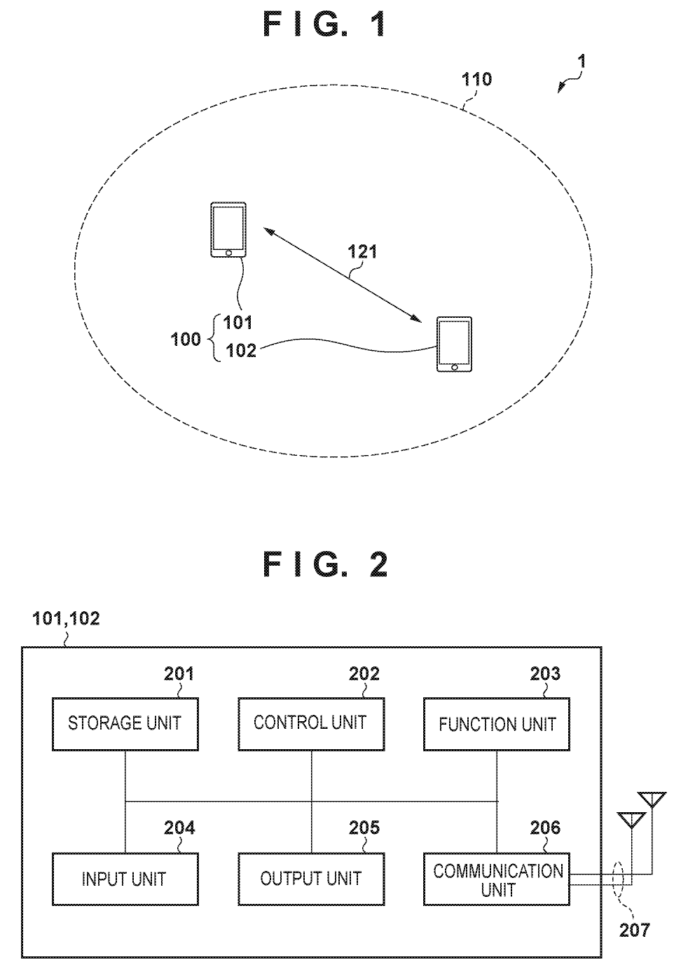

FIG. 1 shows an exemplary configuration of a network according to the present embodiment. The present wireless communication system 1 is configured to include two or more wireless communication apparatuses. For example, the present wireless communication system can be composed of communication apparatuses 101 and 102. Hereinafter, the communication apparatuses 101 and 102 may be referred to as a communication apparatus 100 without distinction.

The communication apparatus 100 can be a wireless communication apparatus capable of executing wireless communication conforming to the standards of the IEEE 802.11 series, including the IEEE 802.11bn standard. The communication apparatus 100 can have functions of a station (STA) conforming to the standards of the IEEE 802.11 series. Note that the communication apparatus 100 may have functions of an access point (AP) conforming to the standards of the IEEE 802.11 series. Note that IEEE is an abbreviation of Institute of Electrical and Electronics Engineers. Furthermore, the IEEE 802.11bn standard can also be referred to as the UHR standard. UHR can be an abbreviation of Ultra High Reliability. The standards of the IEEE 802.11 series can include the IEEE 802.11a/b/g/n/ac/ax/be standards, which are called legacy standards. That is to say, the communication apparatus 100 can support one or more of the legacy standards in addition to the IEEE 802.11bn standard. Conversely, the communication apparatus 100 may support one or more of the legacy standards and may not support the IEEE 802.11bn standard. A network 110 formed by the communication apparatus 101 and the communication apparatus 102 represents a range in which the communication apparatus 101 and the communication apparatus 102 can perform communication. That is to say, in the range of the network 110, the communication apparatus 102 can receive signals transmitted by the communication apparatapparatus 101ignals transmitted by the communication apparatus 102 can be received by the communication apparatapparatus 101ommunication apparatus 100 may support other communication standards, such as Bluetooth^{®}, NFC, UWB, ZigBee, and MBOA, in addition to the standards of the IEEE 802.11 series. Note that NFC is an abbreviation of Near Field Communication, and UWB is an abbreviation of Ultra Wide Band. Also, MBOA is an abbreviation of Multi Band OFDM Alliance. UWB includes wireless USB, wireless 1394, WiNET, and the like. Also, the communication apparatus 100 may support communication standards of wired communication, such as a wired LAN.

Also, the communication apparatus 100 can have a function of discovering each other in accordance with technical specifications of Wi-Fi Direct (WFD), and establishing a communication link without intervention of another access point (AP). For example, one of the communication apparatus 101 and the communication apparatus 102 can play a role of a Group Owner (GO) and the other can play a role of a Client (CL) in an establishment procedure for establishing connection conforming to technical specifications of WFD. In the present embodiment, the communication apparatus 101 can serve as a GO, provide communication parameters to the communication apparatus 102, and construct the network 110, whereas the communication apparatus 102 serving as a CL can receive the communication parameters from the communication apparatus 101 and participate in the network 110. Note that the communication apparatus 102 and the communication apparatus 101 may serve as the GO and the CL, respectively. Also, the communication parameters may be provided by the CL to the GO through Bootstrapping processing, which will be described later.

According to WFD, a method that uses a Probe Request and a Probe Response, and a method that uses a Service Discovery Frame, can be used as methods for discovering a partner apparatus. In the present embodiment, the method that uses a Probe Request and a Probe Response is referred to as WFD R1, and the method that uses a Service Discovery Frame is referred to as WFD R2. In the present embodiment, the communication apparatus 100 may support not only WFD R2, but also WFD R1.

Note that although FIG. 1 shows a state where two communication apparatuses 100 exist, the network 110 may be composed of three or more communication apparatuses 100. Also, in this case, the communication apparatuses 100 may be connected to one another, or one communication apparatus 100 may serve as a hub and connect other communication apparatuses 100 to one another. For example, the network 110 can be constructed based on communication parameters provided by the communication apparatus 101 that plays the role of the GO, and a plurality of communication apparatuses 100 that play the roles of CLs can participate in the network 110. In this case, the communication apparatus 101 can operate as a temporary AP. For example, the communication apparatus 101 can notify other communication apparatuses of the communication parameters by announcing a Beacon. The communication apparatus 100 may be, but is not limited to, any electronic device like a smartphone, a tablet, a mobile telephone, a PC, a video camera, a headset, a printer, or a display. Also, the communication apparatus 100 may be an information processing apparatus, such as a wireless chip, capable of executing wireless communication conforming to the IEEE 802.11bn standard.

The communication apparatus 100 can perform communication with use of wireless signals in such frequency bands as the 2.4 GHz band, 3.6 GHz band, 5 GHz band, and 6 GHz band, or the 45 GHz and 60 GHz bands that are called millimeter waves. The frequency bands used by the communication apparatus 100 are not limited to these, and can be, for example, the Sub-1 GHz band and the like. Also, the communication apparatus 100 can perform communication with use of bandwidths of 20 MHz, 40 MHz, 80 MHz, 160 MHz, 320 MHz, 540 MHz, 640 MHz, 1080 MHz, and 2160 MHz. The bandwidths used by the communication apparatus 100 are not limited to these, and can be, for example, 240 MHz, 4 MHz, and the like. Note that the standards of the IEEE 802.11 series define a frequency channel that uses the 20 MHz bandwidth as a basic channel in such frequency bands as the 2.4 GHz, 5 GHz, and 6 GHz bands. Also, these standards define a plurality of channels that can be used in the frequency bands of the 2.4 GHz, 5 GHz, and 6 GHz bands. Furthermore, these standards enable a certain channel to be used in combination with another neighboring channel. In the present embodiment, the use of a certain channel in combination with another neighboring channel may be referred to as channel bonding. Also, a bundle of channels formed by one channel, or two or more neighboring channels, may be referred to as a communication link (a link). That is to say, one link formed by two channels in the 20 MHz bandwidth uses the 40 MHz bandwidth. Note that the communication apparatus 100 may be a STA Multi-Link device (MLD) or an AP MLD that support Multi-Link (ML), in which communication is performed by establishing a plurality of links simultaneously. In FIG. 1, it is assumed that two wireless links (a link 121 and a link 122) have been established between the communication apparatuses.

### Apparatus Configuration

FIG. 2 shows an exemplary hardware configuration of the communication apparatuses 100 in the present embodiment. The communication apparatus 100 includes a storage unit 201, a control unit 202, a function unit 203, an input unit 204, an output unit 205, a communication unit 206, and an antenna 207. Note that a plurality of antennas may be included. The storage unit 201 is composed of one or more memories, such as a ROM and a RAM, and stores computer programs for performing later-described various types of operations, and various types of information for wireless communication, such as communication parameters. ROM and RAM are acronyms for read-only memory and random-access memory, respectively. Note that other than such memories as the ROM and RAM, a storage medium like a flexible disk, a hard disk, an optical disc, a magneto-optical disc, a CD-ROM, a CD-R, a magnetic tape, a nonvolatile memory card, or a DVD may be used as the storage unit 201. Also, the storage unit 201 may include a plurality of memories and the like. Note that the storage unit 201 can store information related to the states of the self-apparatus, such as setting information that a user has input to the self-apparatus, a remaining amount of a battery included in the self-apparatus, and whether a power-saving operation is in execution.

The control unit 202 is composed of, for example, one or more processors, such as a CPU and an MPU, and one or more memories, and controls the entirety of the communication apparatus 100 by executing computer programs stored in the storage unit 201. Note that CPU and MPU are acronyms for central processing unit and micro processing unit, respectively. The control unit 202 may control the entirety of the communication apparatus 100 in coordination with computer programs and an operating system (OS) stored in the storage unit 201. Also, the control unit 202 generates data and signals (wireless frames) to be transmitted in communication with another communication apparatus. The control unit 202 may include a plurality of processors, such as a multi-core processor, and control the entirety of the communication apparatus 100 with use of the plurality of processors. Also, the control unit 202 executes wireless communication and predetermined processing, such as image capture, printing, and shooting, by controlling the function unit 203. The function unit 203 is hardware intended for the communication apparatus 100 to execute the predetermined processing.

The input unit 204 accepts various types of operations from the user. The output unit 205 performs various types of outputs with respect to the user via a monitor screen and a speaker. Here, the outputs performed by the output unit 205 may be display on the monitor screen, the output of sounds by the speaker, the output of vibrations, and the like. Note that both the input unit 204 and the output unit 205 may be realized using one module, like in the form of a touch panel. Also, each of the input unit 204 and the output unit 205 may be integrated with or separate from the communication apparatus.

The communication unit 206 controls wireless communication conforming to the IEEE 802.11bn standard. Also, the communication unit 206 may control wireless communication conforming to other standards of the IEEE 802.11 series in addition to the IEEE 802.11bn standard, and control wired communication, such as a wired LAN. The communication unit 206 controls the antenna 207 to transmit/receive signals for wireless communication that have been generated by the control unit 202. The communication unit 206 may be composed of a plurality of communication circuits that respectively correspond to a plurality of links. Note that in a case where the communication apparatus 100 supports the NFC standard, the Bluetooth standard, and the like in addition to the IEEE 802.11bn standard, wireless communication conforming to these communication standards may be controlled. Also, in a case where the communication apparatus 100 can execute wireless communication conforming to a plurality of communication standards, it is permissible to adopt a configuration in which communication units and antennas that correspond to the respective communication standards are individually provided. The communication apparatus communicates such data as image data, document data, and video data to a partner communication apparatus via the communication unit 206. Note that the antenna 207 may be configured to be separate from the communication unit 206, or may be configured as one module together with the communication unit 206.

The antenna 207 is an antenna that can perform communication in the 2.4 GHz band, the 5 GHz band, the 6 GHz band, and the like. In the present embodiment, there may be two or more antennas; in a case where the communication unit 206 is composed of a plurality of communication units, there may be antennas that correspond to the respective communication units. Alternatively, there may be different antennas for the respective frequency bands.

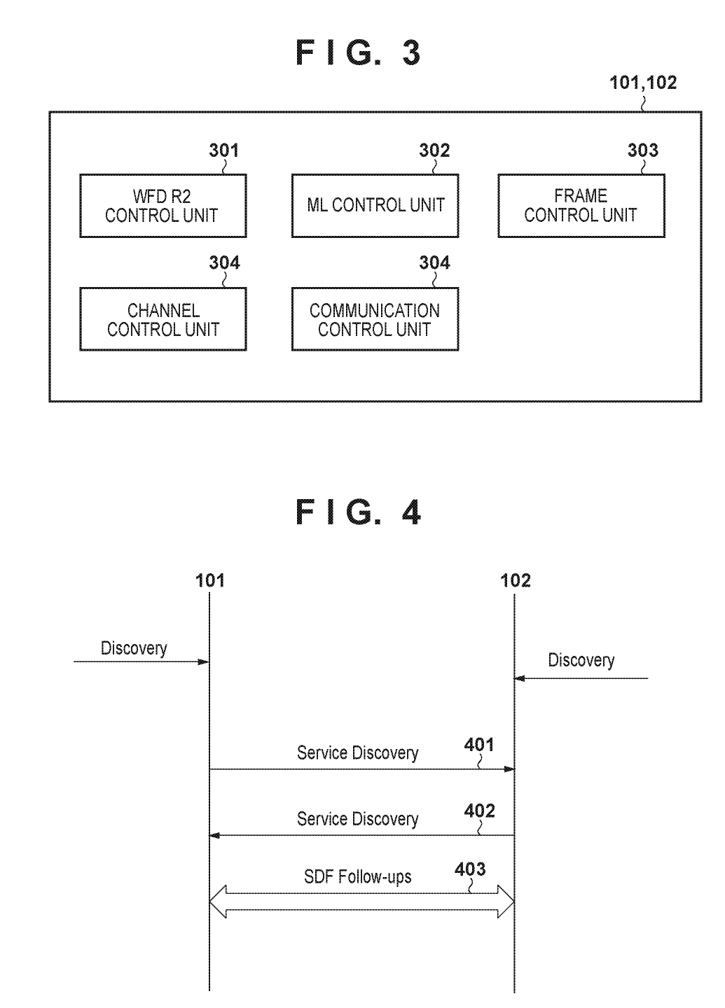

FIG. 3 shows a block diagram of a functional configuration of the communication apparatus 100 according to the present embodiment. The communication apparatus 100 can be configured to include a WFD R2 control unit 301, a Multi-Link (ML) control unit 302, a frame control unit 303, a channel control unit 304, and a communication control unit 305.

The WFD R2 control unit 301 controls processing for discovering a partner apparatus and making a connection with use of a Service Discovery Frame (SDF) in accordance with WFD R2. For example, it can be composed of SDF processing, Bootstrapping processing, and GO Negotiation processing.

The ML control unit 302 is a block for controlling communication start processing for establishing one or more links to be used in wireless communication, processing for controlling functions related to Multi-Link, processing for adding and deleting a link after the start of communication, and communication end processing for deleting every link.

Upon receiving an instruction from the WFD R2 control unit 301 and the ML control unit 302, the frame control unit 303 generates a frame. Also, it analyzes a received frame, and determines whether it is to be processed in the WFD R2 control unit 301 or the ML control unit 302.

Upon receiving an instruction for discovering a partner apparatus from the user, the channel control unit 304 performs control regarding which channel is to be used for transmission of an SDF and for standby for reception.

The communication control unit 305 transmits a frame generated by the frame control unit 303. Alternatively, it transmits a frame that has been received in a channel controlled by the channel control unit 304 to the frame control unit 303. Also, it executes processing for connecting to the partner apparatus in accordance with connection parameters obtained by the WFD R2 control unit 301. The communication control unit 305 can be composed of authentication processing, association processing, and 4-way-handshake (4WHS) processing.

### Flow of Processing

Subsequently, a description is given of a flow of processing executed by the above-described communication apparatus 100, a sequence in the wireless communication system, and so forth.

FIG. 4 shows an example of a sequence until the communication apparatuses 100 discover a partner apparatus in accordance with an instruction from a user or an application in WFD processing. Note that although the communication apparatus 101 transmits frames and the communication apparatus 102 receives the frames in the sequence, the communication apparatus 102 can transmit frames, too. Also, the communication apparatus 101 can receive frames, too.

The communication apparatus 101 receives an instruction for discovering a partner apparatus from the user or the application. For example, it can be determined that the discovery instruction has been received in a case where the output unit 205 has displayed a button for issuing an instruction for executing WFD or a button for issuing an instruction for discovering a partner apparatus with WFD, and the input unit 204 has received a user selection of one of these buttons. Alternatively, it may be thus determined in a case where an indication that WFD is to be performed has been provided via a sound input. Either way, the following procedure is performed in response to a single action for scanning for a partner device in Wi-Fi Direct. In this way, the trouble of a user operation is reduced. Furthermore, the communication apparatus 102 also similarly receives an instruction for discovering a partner apparatus from a user or an application.

The communication apparatus 101 transmits SDFs at a predetermined frequency (401). For example, the communication apparatus 101 transmits an SDF a predetermined number of times at a predetermined time interval in channel 6, which is a Social Channel. The SDFs transmitted from the communication apparatus 101 are also referred to as Search frames. The time interval at which the communication apparatus 101 transmits an SDF may be a fixed interval, or may be changed in accordance with a pseudorandom function. Also, the communication apparatus 102 stands by for reception of SDFs for a predetermined time period at a predetermined time interval. The time interval at which the communication apparatus 102 stands by for reception may be changed in accordance with a pseudorandom function. Also, the length of the time period for which the communication apparatus 102 stands by for reception may be set in advance, or may be dynamically changed by the application in a case where the communication apparatus 102 is battery-driven. Furthermore, although it is assumed that the predetermined frequency at which the communication apparatuses 101 and 102 transmit SDFs or stand by for reception thereof has been set in advance, they may transmit SDFs or stand by for reception thereof in a plurality of frequency bands. In addition, the communication apparatuses 101 and 102 may switch in terms of transmission and reception of SDFs at a predetermined time interval. In the description of FIG. 4, it is assumed that SDFs transmitted by the communication apparatus 101 are received by the communication apparatus 102. Upon receiving an SDF, the communication apparatus 102 returns an SDF (402).

Note that in a case where the communication apparatus 101 is a service requesting side and the communication apparatus 102 is a service providing side, an SDF transmitted by the communication apparatus 101 indicates Subscribe, and an SDF transmitted by the communication apparatus 102 indicates Publish. A transmission source of an SDF indicating Subscribe may be referred to as a Seeker, and a transmission source of an SDF indicating Publish may be referred to as an Advertiser. The Publish transmitted by the communication apparatus 102 may be returned in response to reception of the Subscribe SDF from the communication apparatus 101, or may be transmitted actively in channel 6. Alternatively, both Publish and Subscribe may be transmitted regardless of the provision of and the request for the service. Also, after SDFs have been received, the communication apparatuses 100 may transmit Follow-up frames (403) among the SDFs.

Also, the communication apparatuses 100 may support not only Wi-Fi Direct R2, but also Wi-Fi Direct R1. For example, the communication apparatuses 100 may not only discover a partner apparatus by transmitting SDFs, but also discover a partner apparatus by using a Beacon frame and a Probe Request/Response frame. Furthermore, they may cycle through channels 1, 6, and 11, and attempt to discover a partner apparatus by scanning in each channel. The order in which they cycle through the channels is not restricted. After scanning in every channel, they may remain in a specific channel and only receive frames from a partner apparatus for a certain time period. At this time, the specific channel may be channel 6. They may alternate between a Listen mode in which only a standby for reception is made and a Search mode in which each frame is transmitted until a frame for connection is received from a partner apparatus, or until the user or the application selects a connection destination device.

In this way, the communication apparatus 100 can check the existence of a partner apparatus by transmitting SDFs and standing by for reception thereof. The communication apparatus 100 according to the present embodiment includes, in an SDF to be transmitted, information that makes it possible to identify whether a plurality of links can be established with another communication apparatus, as will be described later. In this way, another communication apparatus that has received the SDF can determine whether to establish a plurality of links with a transmission source of the SDF, and Multi-Link connection can be established.

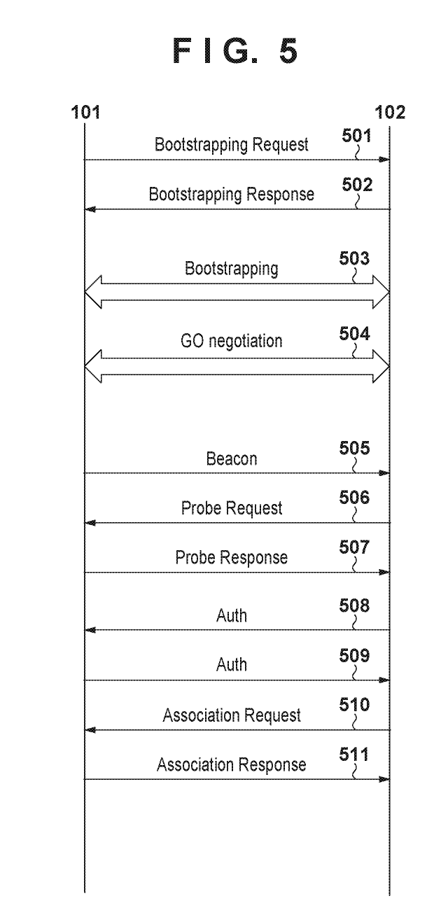

FIG. 5 shows an example of a sequence until a connection is made after the communication apparatus 100 has received SDFs and discovered a partner apparatus in WFD processing. The communication apparatus 101 transmits, to the communication apparatus 102, a Bootstrapping Request for checking a demand about which Bootstrapping method is to be used (501). Note that the Bootstrapping Request may be transmitted from the communication apparatus 102. A Bootstrapping method decides on a parameter delivery method that is not defined by the standards. The parameters include setting items that are necessary for performing wireless communication, such as a service set identifier (SSID), an encryption scheme, an encryption key, an authentication scheme, AKM, a BSSID, and a MAC address. Note that the AKM is a value indicating which authentication protocol and key exchange algorithm are to be used at the time of communication. For example, in a case where the AKM is "SAE", the communication parameters include a password for connecting to an AP and a GO supporting Wi-Fi Protected Access (WPA) 3. Also, in a case where the AKM is "psk", the communication parameters include a Pre Shared Key (PSK)/passphrase for connecting to an AP and a GO supporting WPA2. In a case where the AKM is "1X", the communication parameters include an ID, a password, a public key, and the like for connecting to an AP supporting WPA-Enterprise. The password and the PSK/passphrase are encryption keys at the time of execution of authentication and key exchange that are based on WPA and the IEEE 802.11.

For example, the exchange of parameters may be completed when the communication apparatus 102 has displayed a code image, such as a QR code^{®} and a barcode, describing the parameters, and the communication apparatus 101 has read the code image. In this case, the Bootstrapping Request can indicate whether the code image can be displayed and whether the code image can be read. Alternatively, the Bootstrapping Request can indicate whether tags are supported in near-field wireless communication, such as Near Field Communication (NFC). Also, the Bootstrapping Request can indicate whether a character string or a numerical value, such as a passphrase, can be displayed, whether the character string or the numerical value can be input, and whether a parameter exchange can be triggered by a button. Furthermore, the Bootstrapping Request can indicate, for example, whether parameters for using a Pre-Association Security Negotiation (PASN) can be exchanged using a method that is not prescribed by WFD. The PASN parameters include, for example, public keys of the respective apparatuses. Examples of a method of exchanging the PASN parameters using a scheme that is not prescribed by WFD include Bluetooth and the like. Other than this, a method of exchanging parameters for WFD connection by setting up a temporary AP and STA and making a connection is plausible as a method that is not prescribed by WFD. In FIG. 5, it is assumed that the Bootstrapping Request provides a notification indicating that the parameters are to be exchanged by displaying and reading a QR code^{®}.

The communication apparatus 102 causes the Bootstrapping Response to indicate that a code image is to be displayed (502). With the procedure of 502, it is confirmed that the parameters are to be exchanged as a result of the communication apparatus 102 displaying a code image describing connection parameters, and the communication apparatus 101 reading the code image. The communication apparatus 101 and the communication apparatus 102 exchange the parameters as their respective roles in accordance with the confirmed method (503). Next, the communication apparatus 101 and the communication apparatus 102 perform a GO Negotiation for confirming which one of them is to operate as a GO, and a channel in which the GO is to operate (504). At this time, PASN may be performed in accordance with the parameters that have been exchanged through Bootstrapping to authenticate each other. In FIG. 5, it is assumed that the communication apparatus 101 and the communication apparatus 102 have been determined to operate as a GO and a CL, respectively. As the communication apparatus 101 operates as a GO, it starts to transmit a Beacon (505).

The communication apparatus 102 transmits a Probe Request to connect to the communication apparatus 101 that operates as a GO (506). Upon receiving a Probe Request frame, the communication apparatus 101 returns a Probe Response frame (507). Note that the Beacon frame and the Probe Response frame may be an ML Probe Request frame and an ML Probe Response frame including a Multi-Link Element indicating that ML connection is supported. Upon receiving the Probe Response frame, the communication apparatus 102 transmits an Authentication frame (508).

Upon receiving the Authentication frame, the communication apparatus 101 returns an Authentication frame (509). Upon receiving the Authentication frame, the communication apparatus 102 transmits an Association Request frame (510). Upon receiving the Association Request frame, the communication apparatus 101 returns an Association response frame (511). Thereafter, 4WHS may be performed. Note that the communication apparatuses 100 may make a Multi-Link connection based on information indicating that Multi-Link connection can be established with the received Search frame, Follow-up frame, Beacon frame, or Probe Response frame. As a result, the communication apparatus 101 and the communication apparatus 102 can connect to each other, and transmit/receive data to/from each other.

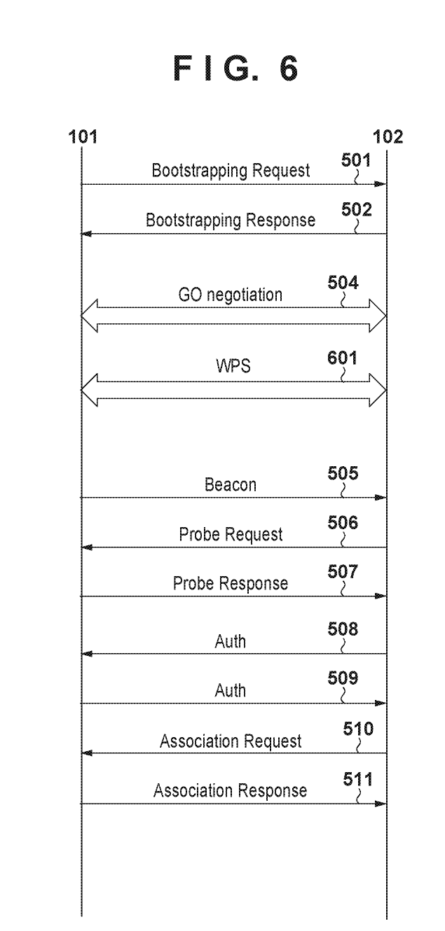

FIG. 6 shows an example of a sequence for a case where the exchange of parameters used in communication is performed without using Bootstrapping, as an example different from FIG. 5.

The sequence shown in FIG. 6 may be performed in a case where, for example, both the communication apparatus 101 and the communication apparatus 102 support WFD R1 and WFD R2, but the Bootstrapping methods presented for WFD R2 do not match. Alternatively, the sequence may be performed in a case where received SDFs indicate that pairing under R2 itself is not supported. The communication apparatus 101 determines that, although the communication apparatus 102 has been discovered by receiving SDFs from the communication apparatus 102, it switches to WFD R1 and exchanges parameters as the indicated Bootstrapping is not supported. For example, in a case where the communication apparatus 101 supports NFC tags and pressing of buttons and the communication apparatus 102 supports NFC tags, inputting of a PIN code, and inputting of a passphrase, the communication apparatus 101 can determine that there is no Bootstrapping method that enables the exchange of parameters. At this time, the communication apparatus 101 may transmit a Probe Request frame or a Probe Response frame to the communication apparatus 102 in order to check whether WFD R1 is supported. Whether WFD R1 is supported can be checked as a result of the communication apparatus 102 returning a Probe Response with a P2P IE attached thereto in response to the Probe Request frame. Note that processing similar to processing that has been described with reference to FIG. 5 is given the same reference numerals, and a description thereof is omitted. Regarding a GO Negotiation 504, as it is performed under WFD R1, PASN is not performed simultaneously. It is assumed that only which one of the communication apparatus 101 and the communication apparatus 102 operates as a GO, and which frequency is to be used for a channel in which one of them operates as a GO, are confirmed. After the GO Negotiation has finished in 504, the communication apparatus 101 and the communication apparatus 102 perform a Wi-Fi Protected Setup (WPS) to exchange parameters (601). The parameters that are exchanged using the WPS include setting items that are necessary for performing wireless communication, such as an SSID, an encryption scheme, an encryption key, an authentication scheme, AKM, a BSSID, and a MAC address. As processing of subsequent 505-511 has been described with reference to FIG. 5, a description thereof is omitted. In this way, communication parameters can be exchanged even in a case where Bootstrapping methods do not match.

### Partner Apparatus Discovery Processing

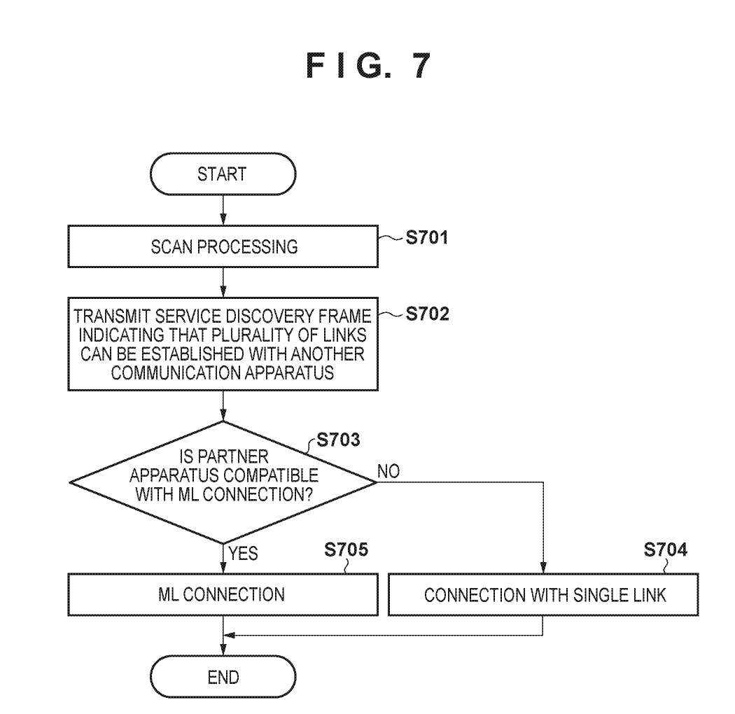

FIG. 7 shows processing until a partner apparatus is detected and a connection is made. The present flowchart is started when a user or an application has issued an instruction for discovering a partner apparatus via Wi-Fi Direct. Alternatively, the present flowchart may be started in a case where an instruction for detecting a partner apparatus has been issued without identifying a standard. Processing of FIG. 7 is realized by the control unit 202 executing programs stored in the storage unit 201.

When a communication apparatus 100 has started to scan for a partner apparatus, it starts to stand by for reception of an SDF in channel 6 (step S701). In a case where the communication apparatus 100 is also functioning under Wi-Fi Direct R1 simultaneously, a time period in which it stands by for reception in channel 6 is 100 msec; thereafter, the communication apparatus 100 stands by for reception while cycling through channels. Note that the time period in which the communication apparatus 100 stands by for reception here is not limited to 100 msec. It may stand by for 200 msec only in channel 6. Also, while standing by for reception in channel 6, the communication apparatus 100 transmits an SDF including a Multi-Link element indicating that ML connection can be established (step S702).

In the processing of step S702, the communication apparatus 100 may transmit an SDF including a Reduced Neighbor Report (RNR) element including information of an Affiliated AP, which is necessary in ML connection. As the Affiliated AP includes information of AP instances operating in a plurality of channels, whether ML connection can be established can be determined based on the SDF. Also, in the processing of step S702, an SDF including a Basic Multi-Link element may be transmitted. The Basic Multi-Link element can include information indicating whether an ML operation is supported, an identifier of an ML device, and channels and bandwidths of respective links. That is to say, the Basic Multi-Link element or the RNR element functions as information indicating that ML connection can be established.

In an example, the SDF transmitted in step S702 can include one or more parameters that are used to establish ML connection. For example, the SDF transmitted in step S702 may include information indicating Modulation and Coding Schemes (MCSs) that can be used in a plurality of links. In this case, the SDF may include information indicating MCSs that can be used in the respective links, or may include information indicating MCSs that can be used in respective frequency bands. In this way, ML connection can be established by using a communication apparatus capable of using an MCS that the communication apparatus 100 desires to use, or a frequency band in which the MCS can be used.

Also, the SDF transmitted in step S702 may include information indicating that a simultaneous transmit and receive mode (STR), in which transmission and reception are performed independently and simultaneously in the plurality of links established by the communication apparatus 100, is enabled. Alternatively, the SDF transmitted in step S702 may include information indicating that non-simultaneous transmit and receive mode (NSTR), in which only transmission or reception is performed simultaneously, is enabled. In this way, ML connection can be established with a communication apparatus capable of using a transmit and receive mode that the communication apparatus 100 desires to use.

Also, the SDFs transmitted in step S702 may include information indicating the frequency bandwidths of the plurality of links that can be established by the communication apparatus 100. For example, they may include such options as 20 MHz, 40 MHz, 80 MHz, 160 MHz, and 320 MHz as frequency bandwidths that can be established in the respective frequency bands, or may include the maximum frequency bandwidth that can be established.

In this way, a communication apparatus with which a throughput is expected via the established ML connection can be determined based on the SDFs.

Also, the SDFs transmitted in step S702 may include information indicating that Enhanced Multi-Link Single Radio (EMLSR), in which the frequency band of any of the plurality of links established by the communication apparatus 100 is dynamically changed, is supported. Alternatively, the SDFs transmitted in step S702 may include information indicating that Enhanced Multi-Link Multi-Radio (EMLMR), in which the number of links established by the communication apparatus 100 is dynamically changed, is supported. In this way, ML connection can be established with a communication apparatus capable of using a transmit and receive mode that the communication apparatus 100 desires to use.

In a case where the communication apparatus 100 has received an SDF while standing by for reception in channel 6, it returns an SDF. Note that in a case where Publish has been received, Subscribe is returned. In a case where Subscribe has been received, Publish is returned. Alternatively, each apparatus may return Follow-up. Upon receiving an SDF, whether the partner apparatus can establish a plurality of links with another communication apparatus is checked based on the element included in the SDF (step S703). In a case where it has been determined that the partner apparatus cannot establish ML connection with another communication apparatus (NO in step S703), the communication apparatus 100 causes processing to proceed to step S704, and executes connection processing for establishing a single link (step S704). In a case where it has been determined that the partner apparatus can establish ML connection with another communication apparatus (YES in step S703), the communication apparatus 100 makes an ML connection to the partner apparatus (step S705). In an example, the communication apparatus 100 may establish ML connection with use of information of the Affiliated AP included in the RNR element of the received SDF, or communication parameters included in the Basic Multi-Link element.

Note that although the description has been provided under the assumption that parameters included in an SDF are used in a case where ML connection is to be established, parameters included in a Beacon frame or a Probe Response frame received during or after the GO Negotiation may be used.

Note that the description has been provided under the assumption that, in the processing of FIG. 7, the communication apparatus 100 establishes ML connection in a case where it has been determined that the partner apparatus can establish a plurality of links in step S703. However, whether to establish ML connection may be determined based on parameters of a plurality of links that the partner apparatus can establish with another communication apparatus.

For example, as described above, whether ML is to be established may be decided on based on at least one or more of information indicating MCSs, information indicating that STR or NSTR is enabled, information indicating bandwidths, and information indicating support for EMLSR or EMLMR, which are included in an SDF. In this case, an application or a user may designate, for the communication apparatus 100, allowable values or a range of the allowable values, or unallowable values or a range of the unallowable values, with respect to each communication parameter.

Note that although the present embodiment has been described in relation to an SDF that is transmitted/received in the WFD processing, no limitation is intended by this. For example, an SDF used in other types of processing, such as Wi-Fi Aware, may include information indicating whether ML connection can be established.

### Frame Configuration of SDF

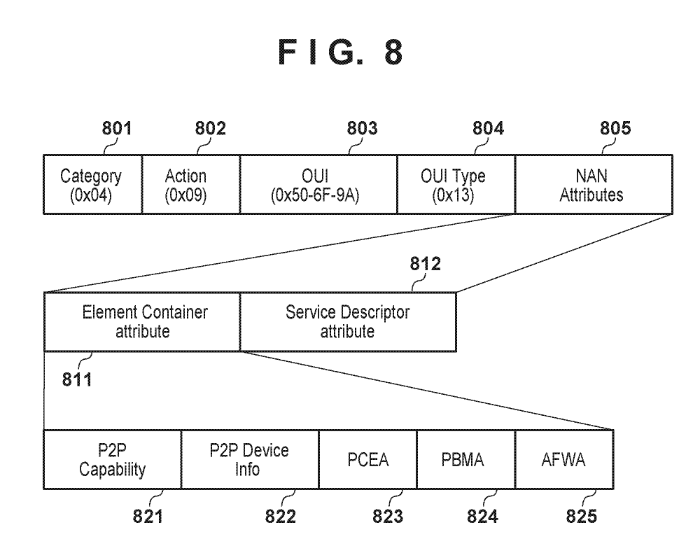

With reference to FIG. 8, a description is now given of an example of a packet format in which an Action Frame Wrapper Attribute (AFWA) is added to an SDF.

An SDF shown in FIG. 8 includes a Category field 801, an Action field 802, an OUI field 803, an OUI Type field 804, and an NAN Attributes field 805. Note that OUI is an abbreviation of Organizationally Unique Identifier, and NAN is an abbreviation of Neighbor Awareness Networking.

As the Category field 801 to the OUI Type field 804 are similar to fields that are prescribed by the WFD standard, a description thereof is omitted. The NAN Attributes field 805 is an example of an Attribute field for providing a notification of the functions of nodes and the availability of services. In the present embodiment, information indicating whether a communication apparatus 100 can establish Multi-Link is stored in the NAN Attributes field 805. The NAN Attributes field 805 includes an Element Container Attribute field 811 and a Service Descriptor Attribute field 812. The Element Container Attribute field 811 includes a P2P Capability field 821, a P2P Device Info field 822, a PCEA field 823, and a PBMA field 824. Also, an AFWA field 825 is added to the Element Container Attribute field 811 according to the present embodiment, and information indicating whether Multi-Link connection can be established is stored in the AFWA field 825. Here, PCEA is an abbreviation of P2P Capability Exchange Attribute, PBMA is an abbreviation of P2P Band Management Attribute, and AFWA is an abbreviation of Action Frame Wrapper Attribute.

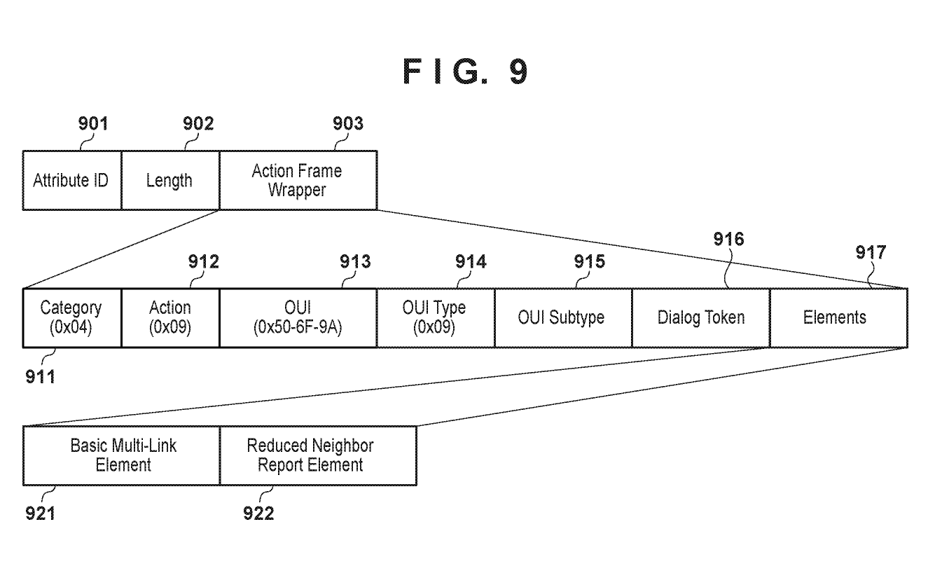

FIG. 9 is a diagram showing an exemplary structure of the AFWA field 825 including an Action Frame Wrapper field that is a P2P Public Action Frame.

The AFWA field 825 includes an Attribute ID field 901, a Length field 902, and an Action Frame Wrapper field 903. As the Attribute ID field 901 and the Length field 902 are similar to fields that are defined by the WFD standard, a description thereof is omitted.

The Action Frame Wrapper field 903 includes a Category field 911, an Action field 912, an OUI field 913, an OUI Type field 914, and an OUI Subtype field 915. Also, the Action Frame Wrapper field 903 includes a Dialog Token field 916 and an Elements field 917. As the Category field 911 to the Dialog Token field 916 are similar to fields that are defined by the WFD standard, a description thereof is omitted. Note that in order to indicate that the SDF supports Multi-Link connection, a dedicated value may be set in the OUI Subtype field 915, or an existing value of the OUI Subtype field 915 may be used; however, no limitation is intended by this.

The Elements field 917 includes a Basic Multi-Link (BML) Element field 921 and a Reduced Neighbor Report (RNR) Element field 922. The BML Element field 921 includes information indicating that ML connection can be established. As described above, the RNR Element field 922 stores communication parameters used to establish ML connection. Therefore, a communication apparatus 100 that has received the SDF can handle the BML Element field 921 and the RNR Element field 922 as information for identifying whether the transmission source of the SDF can establish ML connection.

Also, the Elements field 917 can include information used to establish ML, such as the above-described information indicating MCSs, information indicating that EMLMR/EMLSR is supported, and information indicating that STR/non-STR is supported. Also, although the Elements field 917 may include an information element other than information necessary for establishing ML connection, such as a P2P IE, no limitation is intended by this.

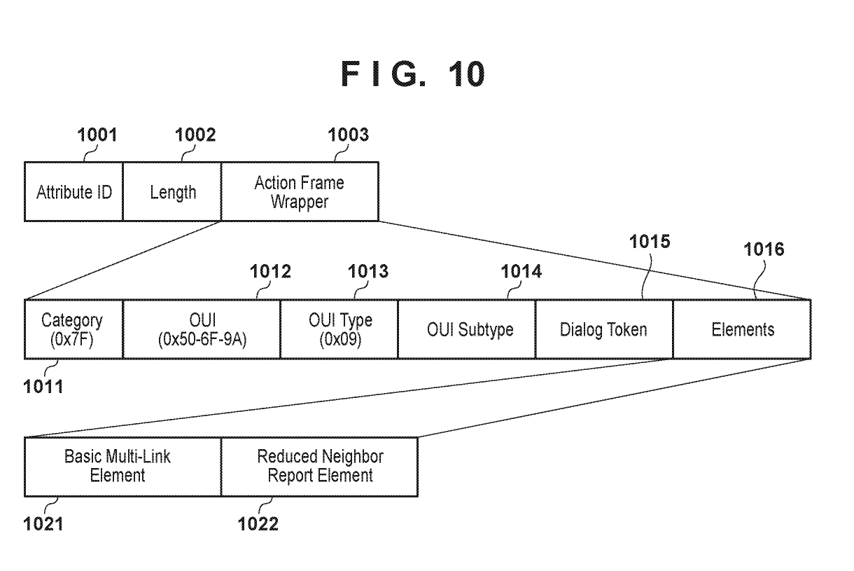

FIG. 10 is a diagram showing an exemplary structure of the AFWA field 825 including an Action Frame Wrapper field that is a P2P Action Frame.

The AFWA field 825 includes an Attribute ID field 1001, a Length field 1002, and an Action Frame Wrapper field 1003. As the Attribute ID field 1001 and the Length field 1002 are similar to fields that are defined by the WFD standard, a description thereof is omitted.

The Action Frame Wrapper field 1003 includes a Category field 1011, an OUI field 1012, an OUI Type field 1013, and an OUI Subtype field 1014. Also, the Action Frame Wrapper field 1003 includes a Dialog Token field 1015, and an Elements field 1016. As the fields from the Category field 1011 to the Dialog Token field 1015 are similar to fields that are defined by the WFD standard, a description thereof is omitted. Note that, similarly to the P2P Public Action Frame shown in FIG. 9, a value of the OUI Subtype field 1014 for providing a notification indicating that ML connection can be established may be set.

The Elements field 1016 can include information used to establish ML connection, such as the above-described information indicating MCSs, information indicating that EMLMR/EMLSR is supported, and information indicating that STR/non-STR is supported. Also, although the Elements field 1016 may include an information element other than information necessary for establishing ML connection, such as a P2P IE, no limitation is intended by this.

Note that although the AFWA is added in the example of FIG. 8, no limitation is intended by this, and another attribute including information necessary for ML connection may be added.

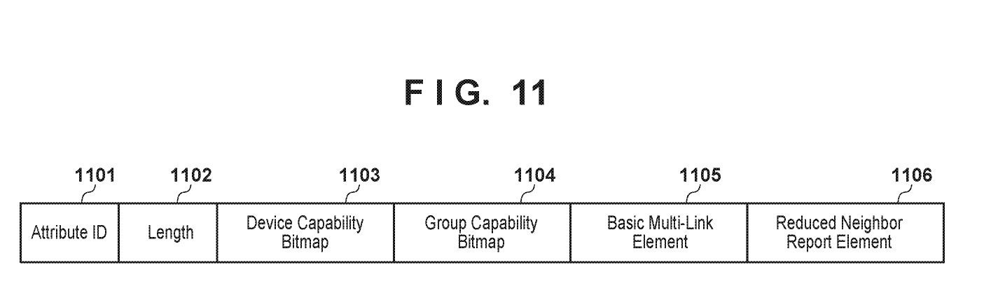

FIG. 11 is a diagram showing an exemplary structure of a P2P Capability field to which information indicating that ML connection can be established has been added. A P2P Capability field 1100 according to the present embodiment includes an Attribute ID field 1101, a Length 1102, and a Device Capability Bitmap field 1103. Also, the P2P Capability field 1100 includes a Group Capability Bitmap field 1104, a BML Element field 1105, and an RNR Element field 1106. As the fields from the Attribute ID field 1101 to the Group Capability Bitmap field 1104 are similar to fields that are defined by the WFD standard, a description thereof is omitted. Also, as the BML Element field 1105 and the RNR Element field 1106 are similar to fields of the same names that have been described with reference to FIG. 9 and FIG. 10, a description thereof is omitted.

Also, similarly to the description of FIG. 9 and FIG. 10, the P2P Capability field 1100 shown in FIG. 11 can also include information used to establish ML connection.

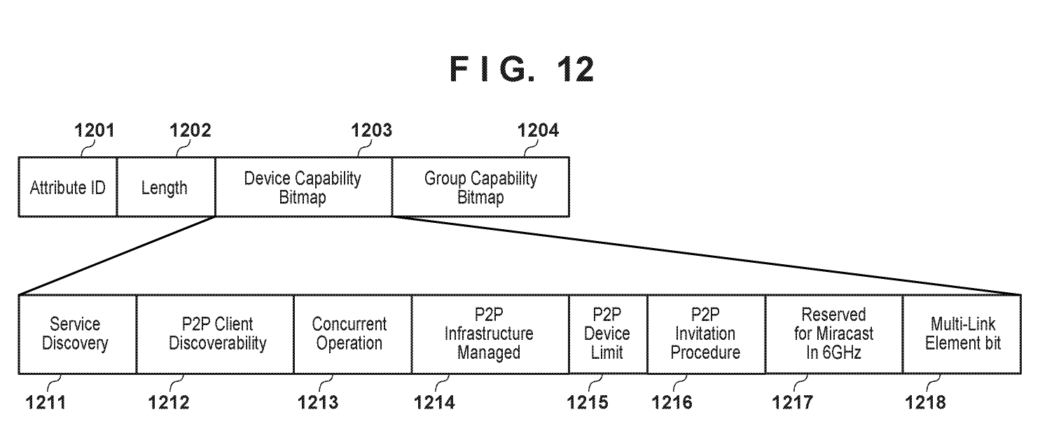

FIG. 12 is a diagram showing a structure of a P2P Capability field that stores information indicating that ML connection can be established. The P2P Capability field 1200 includes an Attribute ID field 1201, a Length field 1202, a Device Capability Bitmap field 1203, and a Group Capability Bitmap field 1204.

The Device Capability Bitmap field 1203 according to the present embodiment includes a Service Discovery field 1211 and a P2P Client Discoverability field 1212. Also, the Device Capability Bitmap field 1203 includes a Concurrent Operation field 1213 and the P2P Infrastructure Managed field 1214. Furthermore, the Device Capability Bitmap field 1203 includes a P2P Device Limit field 1215 and a P2P Invitation Procedure field. In addition, the Device Capability Bitmap field 1203 includes a Reserved for Miracast In 6 GHz field 1217 and a Multi-Link Element Bit field 1218.

As the Service Discovery field 1211 to the Reserved for Miracast In 6 GHz field 1217 are similar to fields of the same names that are defined by the WFD standard, a description thereof is omitted.

The Multi-Link Element Bit field 1218 stores a bit indicating whether ML can be established. Note that information used to establish ML connection, such as the above-described information indicating MCSs, information indicating that EMLMR/EMLSR is supported, and information indicating that STR/non-STR is supported, may be additionally stored. Also, although the Multi-Link Element Bit field 1218 may include an information element other than information necessary for establishing ML connection, such as a P2P IE, no limitation is intended by this. The partner apparatus determines whether ML can be established, and which function is to be enabled/disabled in a case where ML is to be established, based on a Device Capability Bitmap in the received SDF, and performs a connection sequence. Note that information necessary for Multi-Link connection, such as an RNR, may be obtained from a Management Frame, such as a Beacon and a Probe Response, to be received in later connection processing.

As described above, according to the present embodiment, a communication apparatus transmits a Service Discovery Frame (SDF), which includes information that makes it possible to identify whether the communication apparatus can establish a plurality of links with another communication apparatus, without intervention of an access point. Then, a communication apparatus that has received the SDF establishes Multi-Link connection without intervention of an access point in a case where the communication apparatus that is the transmission source of the SDF can establish a plurality of links with another communication apparatus. In this way, convenience can be improved when connecting to another communication apparatus via Multi-Link.

According to the present disclosure, convenience can be improved when a communication apparatus scans for a partner apparatus when making a connection by establishing a plurality of links.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-082854, filed May 16, 2025, which is hereby incorporated by reference herein in its entirety.

What is claimed is:

1. A wireless communication apparatus conforming to an IEEE 802.11 series standard, the wireless communication apparatus comprising:
at least one memory that stores a set of instructions; and
at least one processor that executes the instructions, the instructions, when executed, causing the wireless communication apparatus to perform operations comprising:
receiving a first Service Discovery Frame (SDF) from a partner apparatus without intervention of an access point, the first SDF including first information that makes it possible to identify whether the partner apparatus is capable of establishing a plurality of links with another communication apparatus; and
establishing Multi-Link connection with the partner apparatus without intervention of the access point in a case where the received first information indicates that the partner apparatus is capable of establishing a plurality of links with another communication apparatus.

2. The wireless communication apparatus according to claim 1, wherein
the instructions, when executed, further cause the wireless communication apparatus to perform operations comprising:
transmitting a second SDF to the partner apparatus, the second SDF including second information that makes it possible to identify whether the wireless communication apparatus is capable of establishing a plurality of links with another communication apparatus.

3. The wireless communication apparatus according to claim 2, wherein
the first SDF is a Search frame, and
the second SDF is a Follow-up frame.

4. The wireless communication apparatus according to claim 1, wherein
the first SDF includes a Basic Multi-Link element including the first information.

5. The wireless communication apparatus according to claim 1, wherein
the first SDF includes a Reduced Neighbor Report Element including the first information.

6. The wireless communication apparatus according to claim 1, wherein
the first SDF includes information indicating Modulation and Coding Schemes (MCSs) of a plurality of links.

7. The wireless communication apparatus according to claim 1, wherein
the first SDF includes information indicating that a simultaneous transmit and receive mode (STR), in which transmission and reception are performed simultaneously and independently in a plurality of links, is enabled, or information indicating that a non-simultaneous transmit and receive mode (NSTR), in which only transmission or reception is performed simultaneously in a plurality of links, is enabled.

8. The wireless communication apparatus according to claim 1, wherein
the first SDF includes information indicating that one of a plurality of links supports a 160 MHz bandwidth, or information indicating that one of a plurality of links supports a 320 MHz bandwidth.

9. The wireless communication apparatus according to claim 1, wherein
the first SDF includes information indicating that Enhanced Multi-Link Single Radio (EMLSR), in which a frequency band of any of a plurality of links is dynamically changed, is supported.

10. The wireless communication apparatus according to claim 1, wherein
the first SDF includes information indicating that Enhanced Multi-Link Multi Radio (EMLMR), in which a total number of links is dynamically changed, is supported.

11. The wireless communication apparatus according to claim 1, wherein
the first information is included in an Attribute field.

12. The wireless communication apparatus according to claim 11, wherein
the Attribute field is an Action Frame Wrapper Attribute field.

13. The wireless communication apparatus according to claim 12, wherein
the Action Frame Wrapper Attribute field indicates being a P2P Public Action Frame.

14. The wireless communication apparatus according to claim 12, wherein
the Action Frame Wrapper Attribute field indicates being a P2P Action Frame.

15. The wireless communication apparatus according to claim 1, wherein
the first information is included in a P2P Capability field.

16. The wireless communication apparatus according to claim 15, wherein
the first information is included in a Device Capability Bitmap field.

17. A control method executed by a wireless communication apparatus conforming to an IEEE 802.11 series standard, the control method comprising:
receiving a first Service Discovery Frame (SDF) from a partner apparatus without intervention of an access point, the first SDF including first information that makes it possible to identify whether the partner apparatus is capable of establishing a plurality of links with another communication apparatus; and
establishing Multi-Link connection with the partner apparatus without intervention of the access point in a case where the received first information indicates that the partner apparatus is capable of establishing a plurality of links with another communication apparatus.
